(19) United States
(12) Patent Application Publication
(10) Pub. No.: US 2007/0083397 A1
(43) Pub. Date: Apr. 12, 2007

(54) System and method for establishing electronic funds transfer-based medical payment plans at point of service

(76) Inventor: Wayne A. Bryan, Richmond, VA (US)

Correspondence Address: MAIER & MAIER, PLLC, 128 N. PITT ST., SECOND FLOOR, ALEXANDRIA, VA, 22314, US

(21) Appl. No.: 11/345,267

(22) Filed: Feb. 2, 2006

Related U.S. Application Data
(60) Provisional application No. 60/725,298, filed on Oct. 12, 2005.

(51) Int. Cl. G06Q 40/00

(52) U.S. Cl. 705/4; 705/40

(57) ABSTRACT

A system and method enabling medical providers to establish electronic funds transfer-based recurring payment plans at the time of service and maintain and report on the plan afterwards. This can include a secure internet application for creating managing and tracking payment transactions and business processes required to effectively institute the payment plans and programs.

### PRIORITY

This application claims priority under 35 U.S.C. 119 to U.S. Provisional Patent Application Ser. No. 60/725,298, filed Oct. 12, 2005, the contents of which are hereby incorporated by reference in their entirety.

### BACKGROUND

In the health care field, expenses are affected in some manner by a third party who is separate from the patient and the health care provider. This third party can be any of a variety of entities, such as an insurance provider, an employer, or a state or federal government program or institution. This entity may handle all or some of the health care expenses and may further act as a conduit through which a patient pays for his or her health care expenses.

Due in part to these third parties, the financial responsibility of patients for medical expenses has been steadily increasing for several reasons. For insured patients who are responsible for paying a percentage of their medical expenses, the rise in costs increases the amount of the deductible they pay. Medical insurers are increasing deductibles for standard accounts and introducing new high deductible plans for patients with Medical Savings Accounts. Additionally, there are a growing number of patients without insurance who expenses are also rapidly increasing due to the involvement of other third parties.

Regardless of whether or not a patient has insurance, a medical provider providing treatment to that patient has to set up effective payment programs with their patients. Many of these programs involve payment over time, either directly to the medical provider or to a third party financial institution (e.g. banks, credit cards and financing agencies). While it is possible for a medical provider to check eligibility from an insurance payer and estimate a patient's monetary responsibilities, setting up financing requires an exact total. While it is possible for a medical provider to estimate a patient's monetary responsibilities, setting up financing requires an exact total. Because of the complexity of medical care, with multiple services delivered by multiple entities, the final balance is frequently unknown when the patient leaves the hospital. A further delay is added in the case of insured patients, approximately 70% of those treated, whose total responsibility is known only after the final balance is submitted to an insurance provider and one or more explanation of benefits (EOB) forms are received. The complete process may take several weeks or months.

In the traditional automated third party payor systems in the healthcare industry, a claim for payment is generated by the administrative staff of the medical provider and transmitted to an outside party who processes the claim and forwards it to the third party payors. This can be a time consuming process that lasts several weeks to several months due to various delays. For example, it may take several days for the medical provider's administrative staff to determine the appropriate amount to bill the patient. After the appropriate amount is determined and transmitted, it may take several more days for the outside party to process the claim and forward it to the appropriate third party payor. Finally, when it is received at the third party payor, the claim must be examined and reviewed for correctness and an explanation of benefits must be provided before payment is sent back to the medical provider. The result of this process can be a significant delay between treatment of a patient and payment for that treatment.

FIG. 1 shows an exemplary diagram of an existing insurance-based financing process. In this embodiment, claims are created and processed after the treatment of a patient or delivery of service. In this process, only after the process is complete are the final patient responsibilities established and then traditional payment approaches can be negotiated. First, in step 124, a medical provider can give financial counseling to a patient. Next, in step 126, the insurance claims can be processed. This processing can take, for example, 30-60 days. After the processing, an explanation of benefits can occur in step 128. Next, in step 130, the patient's financial obligations can be established. After the financial obligations are established, other payment approaches can be negotiated and established between the provider and the patient. These approaches can include, but are not limited to, installment loans, credit card charges and/or time payments. After the patient's payment plan is finalized, in step 134 the patient may start the alternative payment method.

The typical result of an existing financing plan, such as that described above, is a delay between the time that services are delivered and a payment approach can be established. Another contact with the patient is required, which can be challenging to accomplish. Patients may be difficult to find, especially if they are in no hurry to be contacted for payment. The urgency of their medical need and to some extent their feeling of responsibility has diminished with time. These challenges result in a loss of revenue for providers.

### SUMMARY

A system and method enabling hospitals, clinics and other medical providers to establish EFT-based recurring payment plans at the time of service and maintain and/or report on the plan afterwards. This includes a secure internet application for creating, managing and tracking payment transactions and business processes required to effectively institute these programs.

In one embodiment, a method of rendering payment to a medical service provider is disclosed. In this embodiment, the amount, if any, of insurance that a person has may be determined. Then a financial obligation of that person can be set based on their level of insurance and the desired medical care. This can be followed by the person and the service provider reaching an agreement regarding the amount and number of payments that the person is required to submit to the service provider. This information may then be stored in a database which can be accessed by a person in a remote location. Additionally, the database may be accessed via an interface that allows the person to make and schedule payments as well as view account information.

### BRIEF DESCRIPTION OF THE DRAWINGS

FIG. 1 is an exemplary diagram showing an existing insurance-based financing process.

FIG. 2 is an exemplary flow chart showing a point of service electronic funds transfer.

FIG. 3 is another exemplary flow chart showing a point of service electronic funds transfer.

FIG. 4 is an exemplary diagram of the hospital admission and financing process.

FIG. 5 is an exemplary diagram of the hospital admission and financing process.

FIG. 6 is an exemplary diagram showing point of service electronic funds transfer for in-patient treatment.

FIG. 7 is an exemplary diagram showing the process from a medical provider.

FIG. 8 is an exemplary diagram showing the process from a medical provider to monetary collection.

FIG. 9 is another exemplary diagram of a point of service electronic funds transfer.

FIG. 10 is an exemplary diagram of a point of service electronic funds transfer as part of an overall patient cost financing process.

FIG. 11 is an exemplary figure showing a login screen to a graphical user interface.

FIG. 12 is an exemplary figure showing a graphical user interface.

FIG. 13 is an exemplary figure showing a graphical user interface.

FIG. 14. is an exemplary figure showing a graphical user interface.

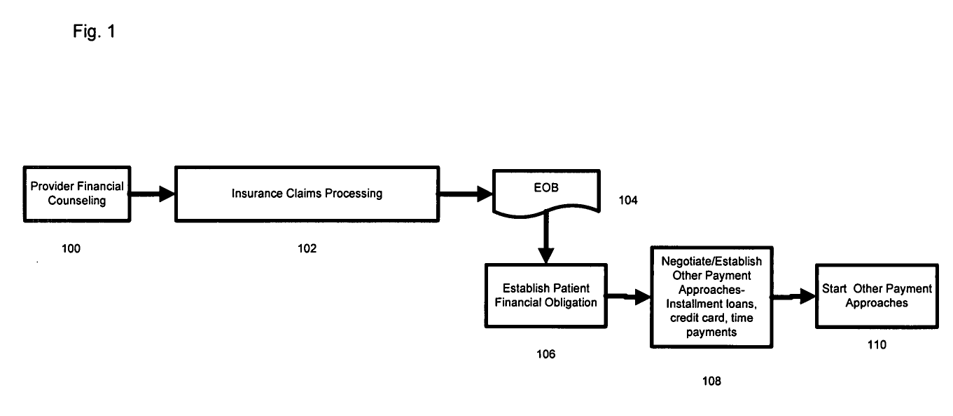

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follow.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

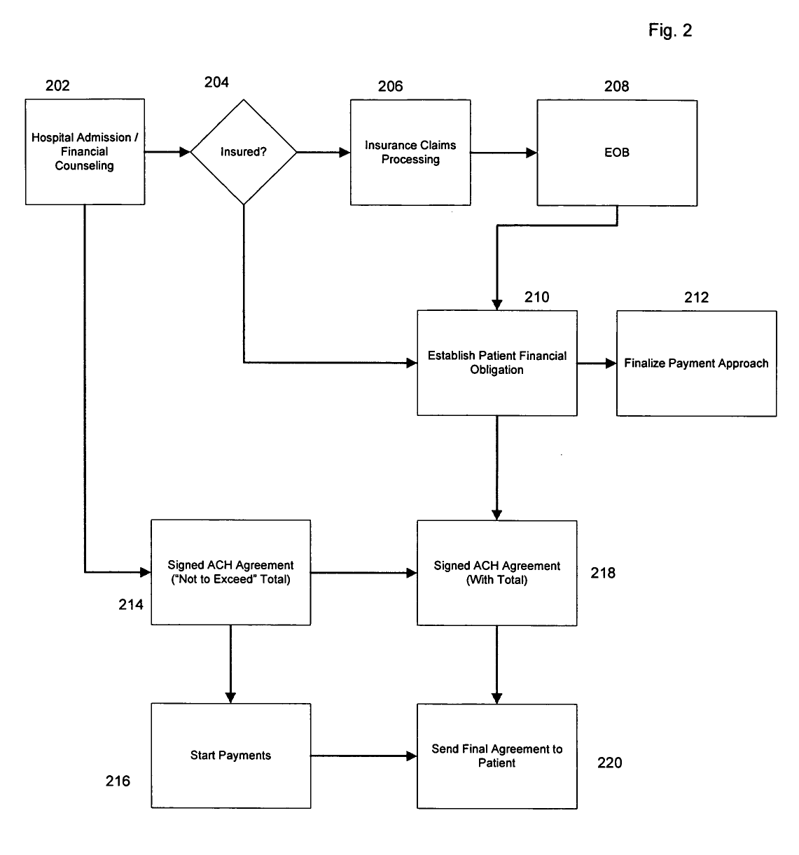

Referring generally to each of the embodiments described in FIGS. 2-8, the payment plans and financial transactions in those embodiments may be monitored in any of a variety of manners. In one embodiment, a secure internet tool for creating, managing and tracking payment transactions and business processes that are necessary to effectively institute the payment plans and programs may be used. The internet tool may be such that it utilizes any of a variety of other internet tools, software and applications. See Preston Gralla, How the Internet Works, Ziff-Davis Press (1996), which is hereby incorporated by reference into this patent application. This tool can be such that it may be accessed by a user with access to the internet, regardless of location, through the use of any of a variety of secure access methods, such as entering a user name and password. In a further embodiment of the invention shown generally in exemplary FIGS. 2-14, the secure internet tool may have the necessary steps and questions from any or all of these exemplary embodiment and figures, allowing a medical provider and a patient seeking to plan the payment of their treatment to set up a payment plan.

FIG. 2 is a flow chart describing a point of service electronic funds transfer (EFT) medical plan. In this embodiment, the point of service may be the location where medical service is provided, such as a hospital, or any other location. In the first step 202 at point of service, a hospital administrator or someone in financial counseling at the provider determines whether or not a particular patient is insured in step 204. If they are insured, the process proceeds to step 206 with the processing of insurance claims. Next, for the insured patient in step 208, an explanation of benefits (EOB) can occur. The EOB is a summary that the health plan can supply to both the medical provider and the insured that outlines all of the medical expenses and services claimed against the plan and information about the patient's financial responsibility. It may provide, for example, the date of service, the type of medical care provided, the amount of services that are covered and the amount of charges that are the patient's responsibility.

Additionally, until a patient receives the EOB, the amount of their financial responsibility is not fixed. It may take some amount of time to assemble and confirm the information required, so there may be a delay between the time of the service delivery and receipt of the EOB. The treatment is often completed and the patient may have already been discharged by the time the EOB is received by the patient. Thus, a delay can exist between the time that service is delivered and the time that a hospital can establish a payment plan requiring the amount be precisely known.

Next, in step 210, regardless of whether the patient is insured or uninsured, the patient and the provider can establish a patient financial obligation and, in 212, finalize the payment approach. The patient may then, in step 218, sign an automated clearing house (ACH) agreement with the total monetary amount that the patient is will to pay and that the provider is willing to provide. The ACH agreement can be an agreement to use an electronic system to transfer funds, such as those dictated by the patient's financial obligation, from one bank to another. This process can then be terminated when the provider gives the patient the final agreement in step 220.

Alternatively, in FIG. 2, a patient and the provider can agree, in step 214, to a first payment plan in the form of a signed ACH agreement, which specifies a maximum dollar amount that a patient is willing to pay and that the provider should not exceed. The amount that the provider should not exceed may be an estimate provided by the provider and may be based on any of a variety of factors. This alternative embodiment may be utilized by a patient before treatment is finished, i.e. for ongoing treatments, or when the total cost of the treatment is unknown at the time treatment begins. Then, in step 216, the patient may start making payments. Finally, the patient and the provider may agree to a second payment plan showing the exact total amount that the patient owes the medical provider in step 218. This process is ultimately terminated when a final agreement is sent to the patient in step 220.

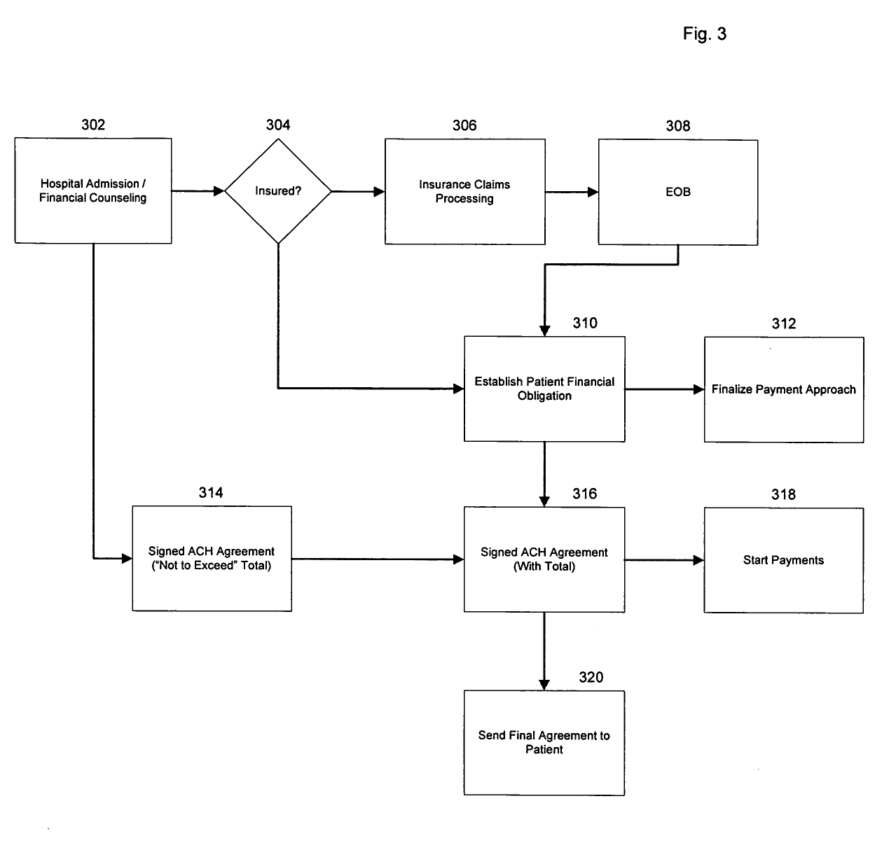

FIG. 3 shows another exemplary flow chart of a point of service EFT. Beginning at step 302, a hospital administrator or financial counselor can, at step 304, determine whether or not a patient is insured. Alternatively, the administrator or advisor may also work with the patient in step 304 to provide an ACH agreement having a “not to exceed” total monetary amount, as above. Meanwhile, an insured patient's insurance claim can be processed in step 306 and an explanation of benefits (EOB) can be presented in step 308, prior to establishing the remaining financial obligation, if any, of the patient in step 310. The patient and the provider can then finalize the payment approach in any of a variety of manners in step 312, such as monthly payments, lump sum or any other payment scheme. Additionally, at step 316, a signed ACH agreement having the total monetary obligation of the patient should be provided to the patient and a finalized agreement should be delivered to the patient in step 320. Additionally, in step 318, the patient may then start making payments in whatever fashion was determined previously.

In another embodiment, an ACH payment amount may be set up before the details of treatment or patient financial responsibility are known. This process can be shown, for example, by moving from step 302 to step 314. In this embodiment, only the payment amount and the payment schedule may be specified in the patient ACH agreement. The ACH agreement in this embodiment therefore may or may not include a “not to exceed” amount. Also, When specific amounts are determined, e.g. with the receipt of the EOB or termination of treatment, a revised agreement specifying the final total can be sent.

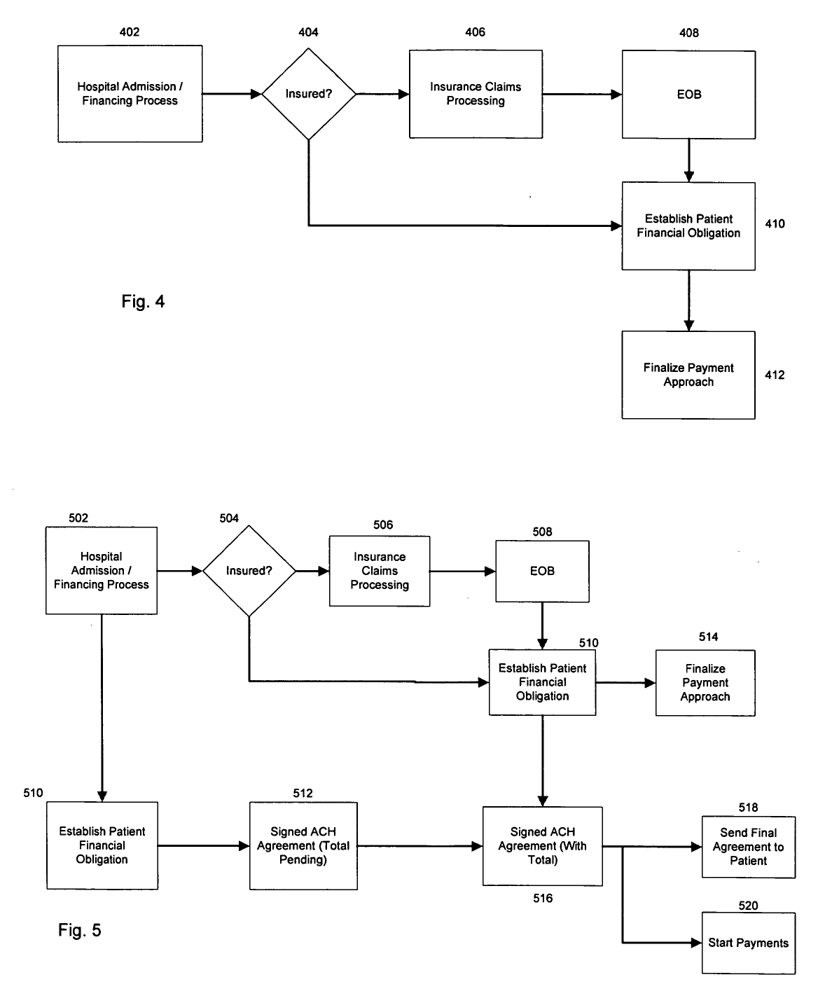

FIG. 4 is another exemplary flow chart showing an embodiment of a hospital admission or financing process. As in the above embodiments, after a patient is admitted for some type of treatment in step 402, a determination should be made over whether or not a patient is insured in step 404. If the patient is insured, their insurance claims may be processed (step 406) and an explanation of their insurance benefits should occur (step 408). For both insured and uninsured patients, a patient financial obligation can be established between the provider and the patient in step 410. Finally, a payment approach by the patient can be finalized and the patient may begin making the appropriate payment or payments in step 412.

FIG. 5 is another exemplary diagram showing another embodiment. Here, after the patient is admitted for treatment at a hospital or care facility in step 502, the admission or financing process determines whether or not a patient is insured in step 504. Similar steps as above may then be taken, such as processing an insurance claim in step 506, providing an explanation of benefits in step 508 and then, for both the insured and uninsured, a patient's financial obligation may then be established in step 510. Additionally, in step 516, a signed ACH agreement indicating the total pending monetary amount may be signed between the parties. At the same time, in step 514, a finalized payment approach may be decided between the patient and the provider. Next, a signed ACH agreement indicating the total amount owed by the patient to the provider, a copy of which is provided to the patient in step 518. Finally, the patient, at step 520, may begin making payments. Alternatively, a patient's financial obligation may be established in step 510 without determining whether or not a patient is insured. Next, in step 512, a signed ACH agreement with the total pending amount and then, in step 516, a signed ACH agreement with the total amount owed can be made. From there, the final agreement may be sent to the patient in step 518 and, in step 520, the patient may start making payments.

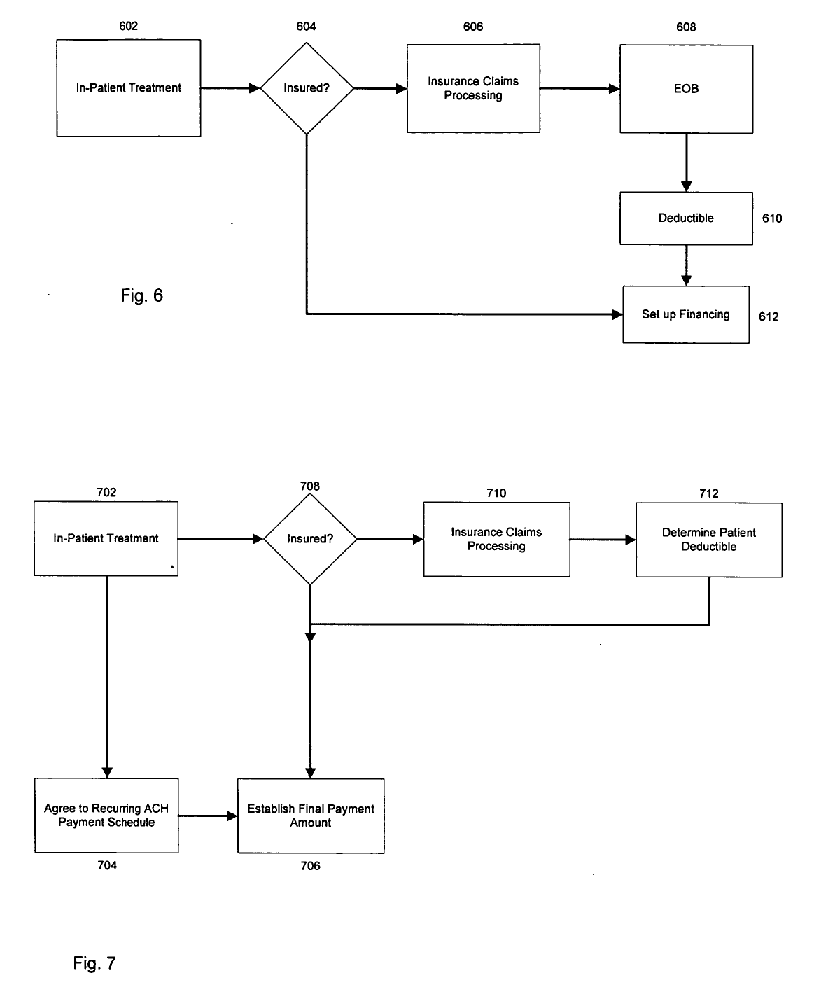

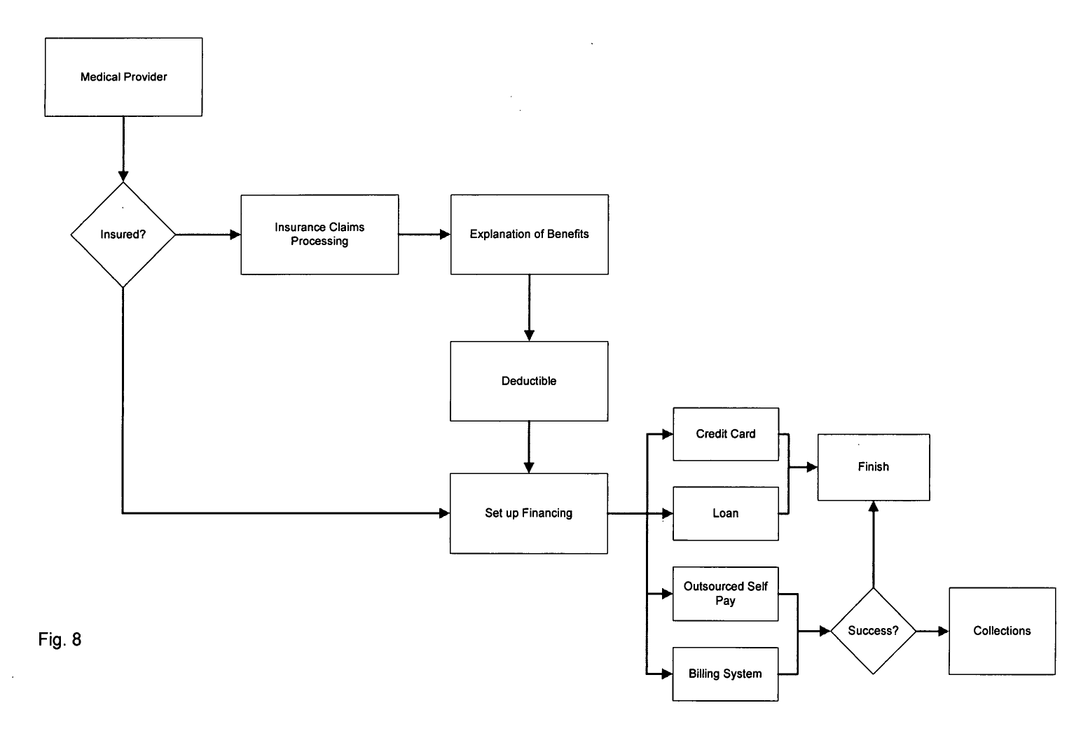

FIGS. 6 and 7 also relate to electronic funds transfer medical payment plans for patients undergoing in-patient treatment. In FIG. 6, after a patient is admitted for in-patient treatment in step 602, it must be determined, in step 604, whether or not the patient is insured. If they are not insured, a financing plan between the treatment facility and the patient is set up in step 612. If the patient is insured, their insurance claim can be processed (as shown in step 606) and an explanation of the insurance benefits may be provided to the patient (step 608). Next, in step 610, the patient is made aware of their deductible and may pay that in full or set up financing (step 612) between themselves and the insurance provider or the hospital.

In another embodiment shown in FIG. 7, the EFT process may begin again when a patient is admitted for in-patient treatment, as shown in step 702. If the patient receiving in-patient treatment is uninsured, they can first agree to a recurring ACH payment schedule, as shown in step 704. Next, in step 706, the patient should establish a final payment amount that the patient will ultimately pay out after the conclusion of the treatment. If the patient is found to be insured in step 708, their insurance claim can be processed in step 710 and a deductible for the patient for the in-patient treatment is determined in step 712. Then, a final payment amount is determined in step 706 that the patient must pay either the treatment provider or their insurance provider.

FIG. 8 is another flow chart showing an exemplary embodiment of an EFT system for use when a patient is receiving treatment from a medical provider. In step 802, the patient has received or is about to receive treatment from a medical provider. Again, in this embodiment, it is next determined, in step 804, whether or not a patient is insured. If the patient is not insured, a financing plan can be set up between the patient and the medical provider at step 806. This financing plan may include credit card charging and payments 808, a loan 810, an outsourced self pay by the patient 812 or a billing system 814. If the patient uses either a credit card 808 or a loan 810 to pay the medical provider, the provider is immediately paid in full and the process is completed at step 816. If the patient opts for outsourced self pay 812 or a billing system 814, the medical provider must attempt to collect the payment from the patient in step 818. If the payments are properly made by the patient, the process is finished in step 816. If, however, the patient does not pay the amount financed in the appropriate time frame and step 818 fails, the amount financed may be sent to a collections agency 820.

Alternatively, if the patient is found to be insured in step 804, their insurance claim is processed in step 822 and an explanation of benefits can occur at step 824. After the deductible is determined in step 826, any amount remaining may be paid in full by the patient or it may be financed in any manner in step 806, such as those mentioned previously with respect to uninsured patients. Further, the same remedies exist for insured patients who do not pay the amount financed in the appropriate time period.

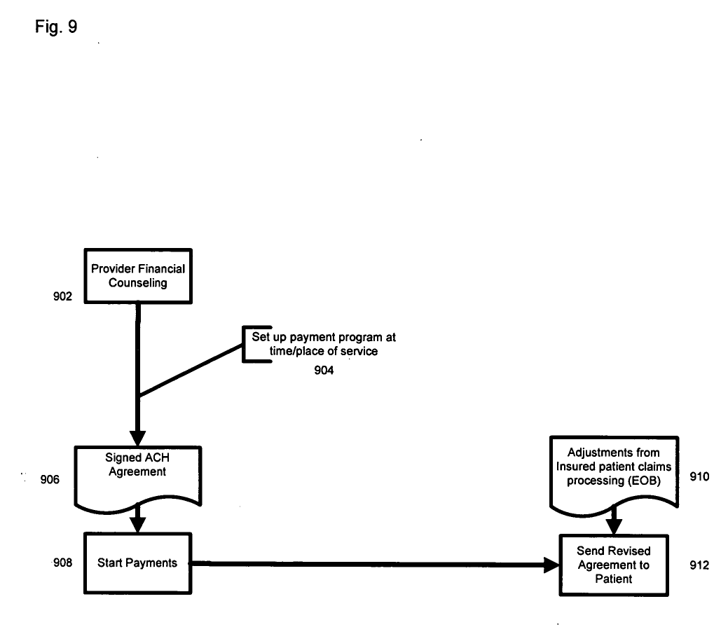

FIG. 9 illustrates another exemplary embodiment of the invention where the payment may be set up at the time of initial service to the patient. Similar to other embodiments, a medical provider may provide financial counseling for a patient in step 902. Then, prior to signing an ACH agreement in step 906, a payment program may be set up at the time and place of the service to the patient in step 904. After the ACH agreement is signed in step 906, the patient may start making payments towards their financial obligation. In a further embodiment, in step 910, adjustments from insured patient claims process and an explanation of an insured patient's benefits may alter the ACH agreement previously signed by the patient. This may, for example, lower a patient's financial obligations. Thus, in step 912, a revised ACH agreement may be sent to the patient outlining the patient's new financial obligations. The patient may then continue paying based on the new agreement.

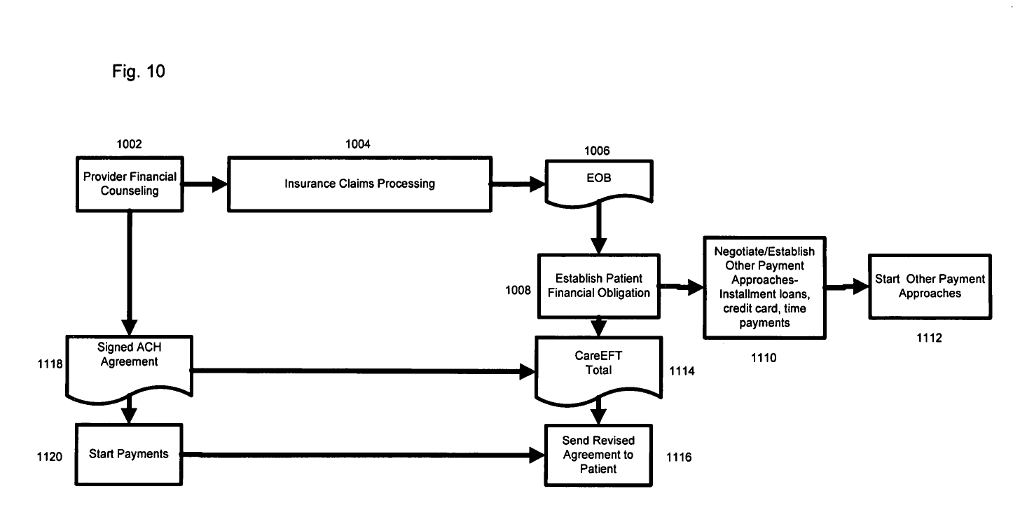

FIG. 10 illustrates another exemplary embodiment of the invention where a point of service electronic funds transfer can be integrated into an existing insurance-payer-based process. This integration can provide the benefit of, for example, initiating patient financial obligations and funds transfers while the insurance process is establishing final costs. In this exemplary embodiment, a medical provider may again provide financial counseling to a patient in step 1002. Next, the insurance may begin processing the claim in step 1004 to begin determining what the total costs will be. This step may take between 14 and 60 days. Next, in step 1006, an explanation of benefits is given to the patient and, in step 1008, the patient's financial obligations are established. The total amount may then be determined in step 1114 and an agreement indicating the total amount may be sent to the patient in step 1116. Additionally, after the patient has received their financial obligation from the insurance provider in step 1008, they may negotiate and establish other payment approaches, such as installment loans, credit card charges, and/or time payments in step 1110. Further, in step 1112, the patient may begin paying of the alternative payment approaches.

Alternatively, in step 1118, the patient may sign an ACH agreement and begin payments based on that agreement in step 1120. After the patient has signed an ACH agreement (1118), a new total patient obligation can be established in step 1114. This new agreement is then sent to the patient in step 1116.

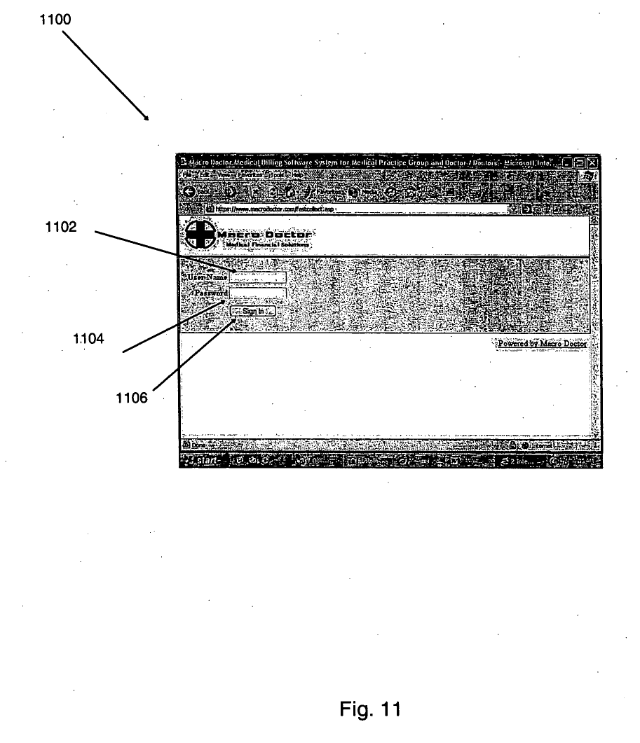

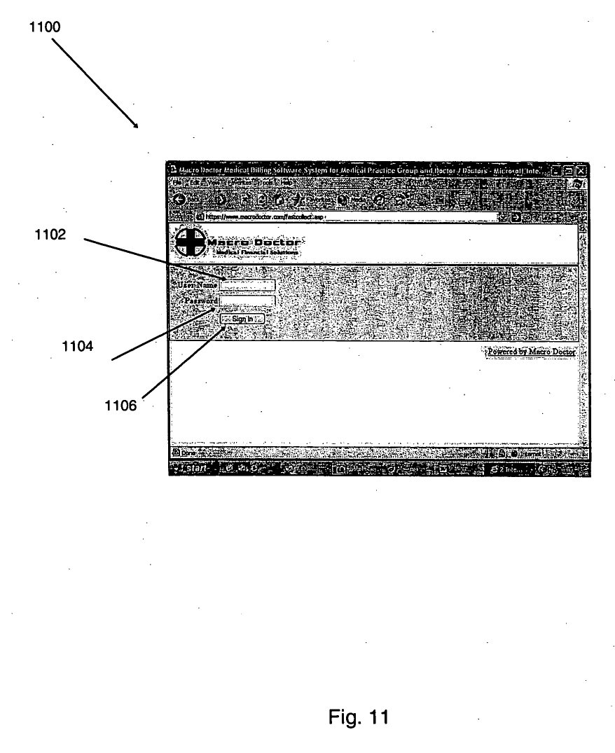

In yet another embodiment, a point of service electronic funds transfer system may have a variety of components, including a web-based graphical user interface, a server-based application, a relational database information repository and a supporting business process and resources. Exemplary figures depicting screen shots of a web-based interface are shown in FIGS. 11-14. Further, this system may use any type of database architecture or database software, for example Microsoft Access®, Microsoft SQL Server®, Oracle®, Sybase®, open source, etc., as well as any development language, for example including but not limited Java, EJB, Microsoft Visual Basic©, Microsoft C#® Microsoft VB.Net®, C++, etc. Additionally, any of a variety of Internet architectures, such as ASP, JSP, Web Services, Microsoft SPS® and other portal technologies and any available network/operating system platforms, for example Microsoft XP/XP Professional®, Unix, Linux, Sun, etc. may be utilized.

In FIG. 11, an exemplary interface for an EFT program is shown. Interface 1100 can include data entry fields 1102 and 1104 for the entry of a user name and a password, respectively. Additionally, button 1106, which may be marked “Sign In”, may be disposed on interface 1100 in such a manner as to allow a user to select or click the button in order to process the entered user name and password. Interface 1100 may be accessed, for example, by any computer with access to the Internet. Additionally, interface 1100 may be displayed on any of a variety of web browsers or internet-browsing programs.

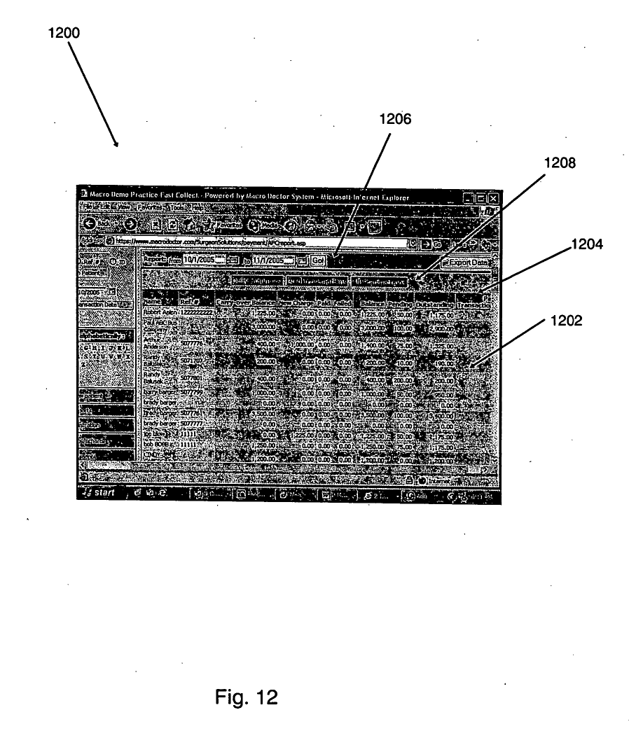

In a further exemplary embodiment, shown in FIG. 12, a variety of data may be accessed after a user or patient logs into the program using interface 1100. In this embodiment, monetary data 1202 may be displayed in table form. This data may include any of a variety of types of data included in toolbar 1204, which can include the patient's name, the provider's alphanumeric patient ID, carryover balance, new charge amount, the amount paid, amounts unpaid due to failed transaction, total balance, payment amount, last payment, last payment date, next payment amount, next payment date, payment pending, and any other relevant payment or account data. Monetary data 1202 may be tailored by a user using toolbar 1206, which can allow for the sorting of the data by specific dates. Further, the program can include toolbar 1208, which can allow a user to view, for example, a daily summary of their account, a list of the paid transactions or a list of all transactions.

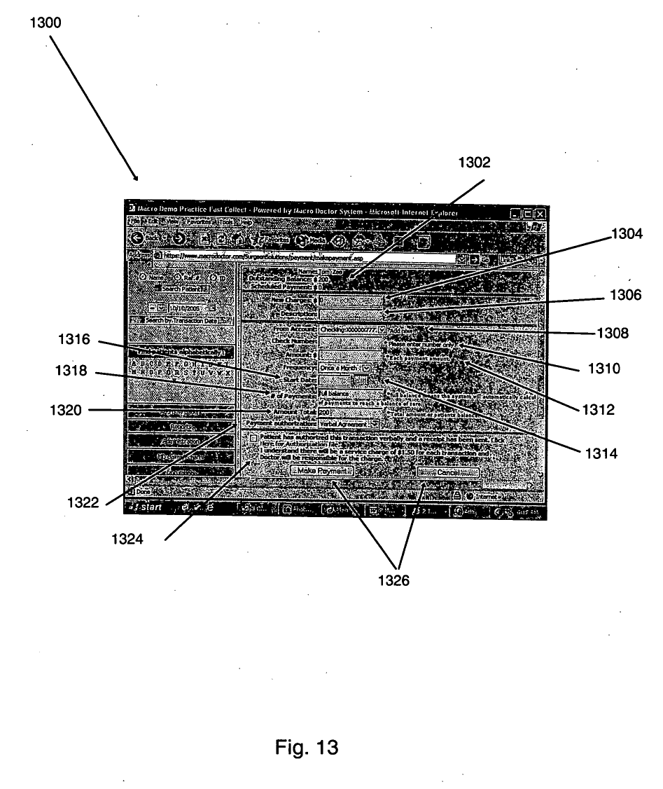

FIG. 13 shows a further exemplary embodiment of the present invention. This embodiment includes interface 1300 that a user may access in order to make payments and schedule recurring payments for their account. Interface 1300 may include a data field showing an account holder's name, the amount of the balance that is outstanding and the amount of a scheduled payment. Additionally, interface 1300 may include fields 1304 and 1306, which can show the amount of new charges and a description thereof, respectively. Further, drop down menu 1308 may show a list of accounts that a user may draw the funds from which to make a payment. Field 1310 can then be utilized by a user to enter an appropriate check number, field 1312 can be used to enter the amount of a payment to be made, and drop down menu 1314 may be used to select the frequency with which a user desires to make a recurring payment. This menu can include, for example, weekly, bi-monthly, or monthly frequencies. Field 1316 may then be used by a user to select a date on which for recurring payments to begin or, alternatively, a date on which to make a specific, one-time payment. Field 1318 can allow a user to select the duration of their payments, i.e. entering “full balance” will schedule recurring payments until the full balance of the account is paid in full. Field 1320 may be used to display the calculated total amount of payments to be made based on factors entered, field 1322 may allow a user to select how the payments have been authorized, for example verbal authorization is required for a one time payment and written authorization for multiple ACH transactions, and section 1324 may include a disclaimer that a user needs to read and a check box that must be checked in order to proceed. Finally, buttons 1326 may be used to either submit a payment or payment schedule or to cancel the entries in above fields and send the user to a different screen or interface.

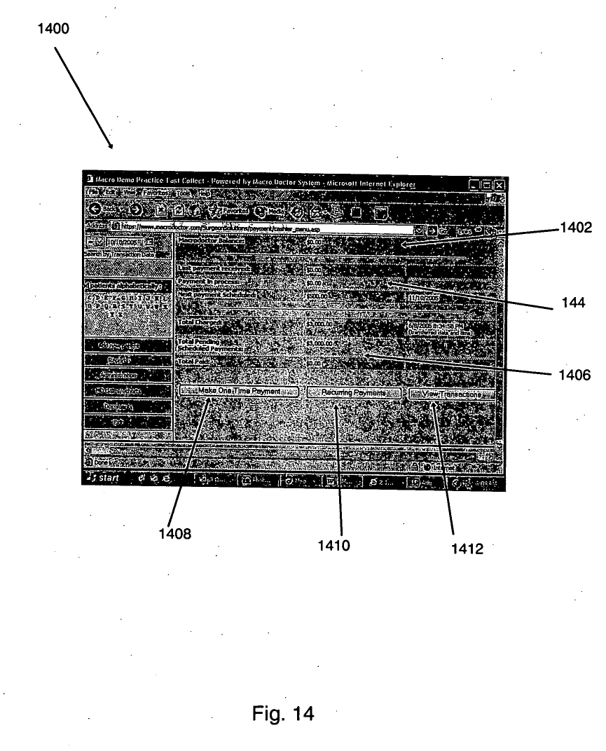

FIG. 14 shows another exemplary embodiment of an EFT program. In this embodiment, interface 1400 can be used to access account information. For example, data field 1402 may show an outstanding balance owed by a certain user. Field 1404 may show account payment info, such as when the last payment was received, the amount of a current payment that is being processed and the date of the next scheduled payment. Data field 1406 may then be used to show the total amount charged to a user, the total amount of pending, scheduled payments and the total amount paid by the user. Finally, buttons 1408, 1410 and 1412 may be disposed on a portion of interface 1400 that allow a user to make a one time payment, view recurring payments and view all transactions, respectively.

In a further embodiment, a web-based interface may allow users, administrators, management and support staff to enter, access and modify data used in the creation, maintenance and management of electronic funds transfer-based payment programs.

The web-based interface can allow user to perform a variety of tasks, such as entering or modifying patient data, such as detailed demographic information and provider-designated patient identification numbers. The interface could also allow users to enter or modify bank account information, such as account type, routing number, account number, account nickname, etc. Users may also set up or modify single or recurring payment programs through the interface, including recurring payment amounts and schedules. Further, through the interface, the users may modify existing programs and payments, such as including, skipping or rescheduling individual payments, marking payments as paid and removing them from the program balance, or removing payments from the schedule without removing them from the program balance. Additionally, users may also access detailed reports and other information about payment program status, such as transactions scheduled, pending and completed, failed transactions, program balances and other detailed historical information through the interface. Further, the interface can allow users to access supporting documentation, such as required agreements or legal documentation, program explanations and marketing materials, scripts to guide patient interactions, online training tutorials, and other information that may make the program easier to explain and use.

In a further embodiment, the provider staff responsible for administering the electronic funds transfer system may use the interface to add or modify system users, such as including setting up user names and passwords, and disabling accounts.

Additionally, the interface may allow the electronic funds transfer system management and support to add, modify, enable and disable new provider organizations. (Although new providers may have the ability to enter their own information into the interface, only the management or other authorized parties will have the ability to enable accounts.) Also, management may be able to access detailed reports and other information about the program as a whole, such as scheduled, pending, completed and failed transactions, program balances and other detailed historical information. In addition, management may also be able to identify and resolve issues with specific transactions and program functionality.

Further, a server-based application can support the functionality accessed through the user interfaces. This application may have programming code components implemented on an n-tier architecture. This code can encapsulate business rules, data input/output and transaction processes. It may also create the file required for the Federal Reserve ACH transactions as well as receiving and processing information from the ACH and banking processes.

Additionally, information can be tracked and stored in a relational database system. This can allow all levels of users to access detailed reports and conduct sophisticated analytics of the data, including, for example, transaction forecasts and history, individual user effectiveness and derived best practices.

Business processes and resources that may be implemented to use the system may be provided online and offline in printed and electronic formats. These can include methods and best practices for setting up the system in provider environments to take advantage of its unique capabilities at point of service and additional methods and best practices for payment plan conversion and collection applications. Further, detailed patient interaction scripts, incorporation the best ways of explaining the program to prospective participants, anticipated concerns and objections and related answers may be used. Also, methods and best practices for managing the system, increasing amounts collected and motivating relevant staff members may be implemented. Further, performance measurements and benchmarks, allowing providers to determine how their use of the system compares with similar organizations can be used with the system. For further information regarding ACH rules and agreements, see The Federal Reserve Uniform Operating Circular, Regulation E and Official Staff Commentary, Electronic Funds Transfer Act, Federal Tax Deposit Payments and Title 31 CFR Parts 208 and 210, which is hereby incorporated by reference in its entirety. Additionally, see the 2006 ACH Operating Rules and Guidelines, published by the National Automated Clearing House Association (NACHA), which is also hereby incorporated by reference in its entirety.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method of rendering payment, comprising:
determining if a person is insured for medical care;
establishing a financial obligation for the person;
creating a payment agreement between the person and a service provider to make payments of the financial obligation;
entering the agreement into a database; and
providing the person with a copy of the agreement.

2. The method of claim 1, further comprising revising the financial obligation for the person at the completion of the medical care.

3. The method of claim 1, further comprising having the person begin payments on the financial obligation prior to the completion of the medical care.

4. The method of claim 1, further comprising offsetting the financial obligation of the person through the use of other payment options.

5. The method of claim 1, wherein the database that the agreement is entered into may be accessed remotely.

6. The method of claim 1, wherein the database that the agreement is entered into may be accessed via the Internet.

7. The method of claim 1, wherein the database that the agreement is entered into houses additional information about the person entering the agreement.

8. The method of claim 1, wherein the database that the agreement is entered into includes financial account information, balance information, payment information, payment timing information, payment tracking information and personal information.

9. The method of claim 1, wherein the payment agreement is an automated clearing house (ACH) agreement.

10. A system for processing fees, comprising:
admitting a person to a care facility;
determining the amount of insurance of the person for the care to be received;
establishing a financial obligation that the person receiving the care is responsible for;
entering the person receiving the care into an automated clearing house (ACH) agreement;
storing the ACH agreement in a database; and
receiving payments from the person receiving the care.

11. The system of claim 10, further comprising:
offsetting the financial obligation of the person receiving the care by establishing other payment approaches.

12. The system of claim 11, wherein the other payment approaches include at least one of an installment loan, a credit card payment and a time payment.

13. The system of claim 10, wherein the database can be accessed through a graphical user interface accessible via the Internet.

14. The system of claim 10, wherein the database further houses financial and personal information of the person receiving care.

15. The system of claim 14, wherein the person receiving care can view and alter their financial and personal information by accessing the database.

16. The system of claim 15, wherein the person receiving care may make payments, schedule payments, alter payments and track payments by accessing the database.

17. The system of claim 10, wherein the financial obligation is determined prior to the person receiving the care and adjusted after the person receives the care.

18. The system of claim 10, wherein the person does not interact with the care facility after they receive the care.

19. The system of claim 10, wherein the database may be accessed by care facility administrators to view the account information of a person.

20. A service cost payment system, comprising:
a step for determining the amount of insurance of a person;
a step for assigning a total cost obligation to the person;
a step for having the person sign a payment agreement; and
a graphical user interface from which the person can schedule and make payments against the total cost obligation.
